(19) United States
(12) Patent Application Publication
(10) Pub. No.: US 2023/0295382 A1
(43) Pub. Date: Sep. 21, 2023

(54) SYSTEMS AND METHODS FOR DRYING AND DEODORIZING LIGNIN

(71) Applicant: Domtar Paper Company, LLC, Fort Mill, SC (US)

(72) Inventors: Michel Jean, Fort Mill, SC (US); Connor Mackinnon, Fort Mill, SC (US)

(21) Appl. No.: 17/906,764

(22) PCT Filed: Mar. 19, 2021
(86) PCT No.: PCT/US2021/023182

§ 371 Date: Sep. 20, 2022

Related U.S. Application Data
(60) Provisional application No. 62/992,252, filed on Mar. 20, 2020.

(51) Int. Cl. C08H 7/00; F26B 5/16; B01J 20/08; B01J 20/28; C08L 97/00

(52) U.S. Cl. CPC C08H 6/00; F26B 5/16; B01J 20/08; B01J 20/28054; B01J 20/28016; C08L 97/005

(57) ABSTRACT

In a particular implementation, a system for drying lignin may include a mixer configured to receive lignin and one or more types of desiccant beads and to mix the lignin with the one or more types of desiccant beads. The one or more types of desiccant beads may be configured to reduce a moisture content of the lignin by adsorbing moisture from the lignin into the one or more types of desiccant beads. The system may further include a separator coupled to the mixer and configured to separate the lignin from the one or more types of desiccant beads.

### CROSS-REFERENCE TO RELATED APPLICATIONS

This is a U.S. National Phase Application under 35 U.S.C. § 371 of International Application No. PCT/US2021/023182, filed Mar. 19, 2021, which claims priority to, and the benefit under 35 U.S.C. § 119(e) of, U.S. Provisional Application No. 62/992,252, filed Mar. 20, 2020, the contents of each of which are fully incorporated herein by reference.

### FIELD OF DISCLOSURE

The present invention relates generally to systems and methods for drying lignin.

### BACKGROUND

Lignin may be used in a variety of products. Lignin is a complex organic polymer found in plants and is not composed of carbohydrate monomers, such as sugars. Lignin may be a by-product of a pulping process, and thus, using lignin in other products increases the revenue created by the pulping process. Typically, lignin formed as a result of a pulping process has a moisture content of approximately 35%, such that the lignin is approximately 65% lignin and approximately 35% water. Such “wet” lignin may not be suitable for use in some types of products. Although there are techniques for drying the lignin or otherwise reducing the moisture content of the lignin, such techniques typically involve heating the lignin to high temperatures. However, heating the lignin can result in degradation of the lignin, reducing the yield and/or the suitability of the lignin for use in some products.

### SUMMARY

The present disclosure is related to systems and methods of drying lignin using desiccant beads. To illustrate, wet lignin, such as lignin may have a moisture content of approximately 35%, as one non-limiting example, and may be mixed in a mixer with one or more types of desiccant beads. In some implementations, the one or more types of desiccant beads may include activated alumina desiccant beads that may include porous aluminum oxide, or other types of desiccant beads, as further described herein. Mixing the wet lignin with the one or more types of desiccant beads may enable moisture from the wet lignin to be transferred to the one or more types of desiccant beads through adsorption, resulting in dry lignin and wet desiccant beads. In some implementations, dry lignin may have a moisture content of approximately 5% or less. The dry lignin may then be separated from the one or more types of desiccant beads via a separator. As used herein, drying lignin refers to reducing a moisture content of lignin. In this manner, lignin may be dried via a process that occurs at room temperature, or near room temperature, thereby preventing degradation to the lignin that would occur during drying processes at higher temperatures. The dry lignin formed by this process may be more suitable for use in a wider variety of products than the wet lignin, thereby improving the utility of the lignin. Additionally, the mixing process may reduce a sulfurous odor of the lignin, which may enable the lignin to be used in products, such as food packaging, in which an odor may be a limiting factor.

In some implementations, the systems of the present disclosure may include a regeneration loop that enables the one or more types of desiccant beads to be reused for drying lignin. To illustrate, the system may include a dryer that is configured to receive the wet desiccant beads from the separator and to dry the wet desiccant beads. Once the one or more types of desiccant beads are dried, the one or more types of desiccant beads may be mixed with additional lignin to dry the additional lignin. Thus, desiccant beads may be reused, reducing the cost of materials needed for the lignin drying process.

Some implementations of a present system for drying lignin may include a mixer configured to receive lignin and one or more types of desiccant beads and to mix the lignin with the one or more types of desiccant beads. The one or more types of desiccant beads may be configured to reduce a moisture content of the lignin by adsorbing moisture from the lignin into the one or more types of desiccant beads. The system may further include a separator coupled to the mixer and may be configured to separate the lignin from the one or more types of desiccant beads.

In some of the foregoing implementations, the lignin may have approximately a 35% moisture content prior to mixing in the mixer, and the lignin may have approximately a 5% moisture content after separation at the separator. Additionally, or alternatively, an odor of the lignin may be significantly reduced after mixing in the mixer. Additionally, or alternatively, the one or more types of desiccant beads may include activated alumina desiccant beads. In some such implementations, the activated alumina desiccant beads may include porous aluminum oxide. Additionally, or alternatively, the one or more types of desiccant beads may include silica gel beads, activated charcoal, calcium sulfate, calcium chloride, calcium oxide, activated carbon, molecular sieves, montmorillonite clay, metal salts, phosphorous compounds, or any combination thereof.

In some of the foregoing implementations, the system may further include a dryer coupled to the separator and may be configured to receive the one or more types of desiccant beads and to dry the one or more types of desiccant beads such that the one or more types of desiccant beads may be provided to the mixer for use in mixing with additional lignin. In some such implementations, the system may include an oil heater coupled to the dryer and may be configured to provide heated oil to the dryer. The heated oil may be configured to heat the dryer during a drying process of the one or more types of desiccant beads. Additionally, or alternatively, the system may include a dust collector coupled to the dryer and may be configured to remove dust from the dryer.

Some implementations of a present method for drying lignin may include receiving lignin and receiving one or more types of desiccant beads. The method may also include mixing the lignin with the one or more types of desiccant beads. The one or more types of desiccant beads may be configured to reduce a moisture content of the lignin by adsorbing moisture from the lignin into the one or more types of desiccant beads. The method may further include, after mixing the lignin with the one or more types of desiccant beads, separating the lignin from the one or more types of desiccant beads.

In some of the foregoing implementations, the lignin may be mixed with the one or more types of desiccant beads until the lignin has approximately a 5% moisture content. Additionally, or alternatively, the lignin may be mixed with the one or more types of desiccant beads until an odor of the lignin is significantly reduced. Additionally, or alternatively, the method may include, after separating the one or more types of desiccant beads from the lignin, drying the one or more types of desiccant beads. In some such implementations, the method may further include, after drying the one or more types of desiccant beads, providing the one or more types of desiccant beads for mixing with additional lignin.

Some implementations of a present article of manufacture may include lignin having a moisture content of approximately 5% or less.

As used herein, various terminology is for the purpose of describing particular implementations only and is not intended to be limiting of implementations. For example, as used herein, an ordinal term such as “first,” “second,” “third,” etc., used to modify an element, such as a structure, a component, an operation, etc., does not by itself indicate any priority or order of the element with respect to another element, but rather merely distinguishes the element from another element having a same name but for use of the ordinal term. The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; for example, substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example. Some details associated with the aspects described above and others are described below.

Some details associated with the aspects are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram of an example of a system for drying lignin in accordance with some embodiments of the present disclosure.

FIG. 2 is a block diagram of an example of a system for drying lignin and for reusing desiccant beads in accordance with some embodiments of the present disclosure.

FIG. 3 is a flow diagram of an example of a method of drying lignin in accordance with some embodiments of the present disclosure.

### DETAILED DESCRIPTION OF ILLUSTRATIVE EMBODIMENTS

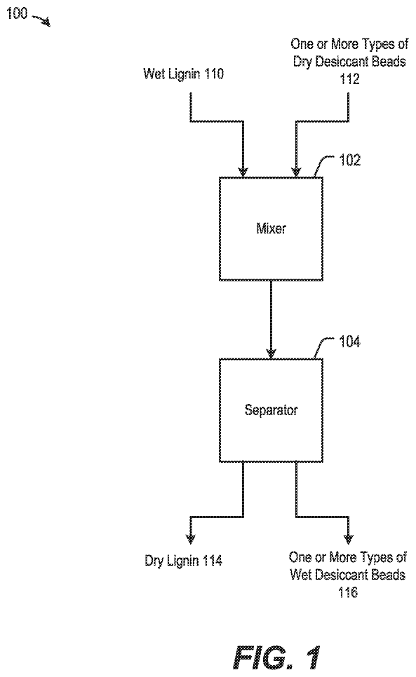

Referring to FIG. 1, a system 100 for drying lignin is shown. System 100 may include a mixer 102 and a separator 104 coupled to mixer 102, such as via coupling to an output of mixer 102. System 100 may be configured to dry lignin such that a moisture content of the lignin is reduced. Lignin is a complex organic polymer found in plants and is generally not composed of carbohydrate monomers, such as sugar. In some implementations, the lignin may be a by-product of the Kraft pulping process, an example of such a lignin being referred to as BioChoice® lignin, or any other pulping process or a by-product of a soda pulping process. BioChoice is a registered trademark of Domtar Corporation. The lignin may be sized based on the process used to produce the lignin. For example, the particle size for Kraft lignin from the LignoBoost® process can be from approximately 100 to approximately 300 microns. LignoBoost is a registered trademark of Valmet Corporation. Additionally, or alternatively, the lignin may be a result of the LignoForce® process or other lignin processing process. LignoForce is a registered trademark of FPInnovations.

Mixer 102 may include or correspond to a tumble mixer. In some implementations, mixer 102 may include a V-blender to combine two input materials. In other implementations, mixer 102 may be a different type of mixer. In some implementations, mixer 102 may be 10 cubic feet in volume. Mixer 102 may be configured to receive wet lignin 110 and one or more dry desiccant beads 112 and to mix wet lignin 110 with one or more dry desiccant beads 112. In some implementations, mixer 102 may be configured to mix wet lignin 110 with one or more types of dry desiccant beads 112 for a time period that includes, or is between any two of: 15 minutes, 20 minutes, 25 minutes, 30 minutes, 35 minutes, or 40 minutes. In other implementations, mixer 102 may be configured to mix wet lignin 110 with one or more types of dry desiccant beads 112 for other time periods.

In some implementations, wet lignin 110 may have a moisture content that includes, or is between any two of: approximately 25%, approximately 30%, approximately 35%, approximately 40%, approximately 45%, or approximately 50%. In a particular implementation, wet lignin has a moisture content of approximately 35%, such that wet lignin includes approximately 65% lignin and approximately 35% water.

One or more types of dry desiccant beads 112 may be configured to reduce a moisture content in wet lignin 110 by adsorbing moisture from the lignin into one or more types of dry desiccant beads 112. The moisture may be transferred from wet lignin 110 to one or more types of dry desiccant beads 112 via an adsorption process. This moisture transfer may result in dry lignin 114 and one or more types of wet desiccant beads 116. In some implementations, dry lignin 114 may have a moisture content that includes, or is between any two of, approximately 20%, approximately 15%, approximately 10%, approximately 5%, or approximately 1%. In some implementations, one or more types of dry desiccant beads 112, and/or one or more types of wet desiccant beads 116, include activated alumina desiccant beads. The activated alumina desiccant beads may include porous aluminum oxide. Alternatively, one or more types of dry desiccant beads 112 and/or one or more types of wet desiccant beads 116 may include silica gel beads. In other implementations, one or more types of dry desiccant beads 112 and/or one or more types of wet desiccant beads 116 may include other materials, such as activated charcoal, calcium sulfate, calcium chloride, calcium oxide, activated carbon, molecular sieves, montmorillonite clay, some metal salts, some phosphorous compounds, or other desiccants. Molecular sieves may include synthetic porous crystalline aluminosilicates, which may also be referred to as synthetic zeolite. Separator 104 may be configured to receive a mixture of dry lignin 114 and one or more types of wet desiccant beads 116 from mixer 102. Separator 104 may also be configured to separate dry lignin 114 from one or more types of wet desiccant beads 116. In some implementations, separator 104 may include or correspond to a screen or a vibratory screener. Separator 104 may be configured to separate elements having a size that is less than a threshold, such as dry lignin 114, from elements having a size that is greater than the threshold, such as one or more types of wet desiccant beads 116. For example, elements having a size that is less than the threshold may pass through a screen, while elements having a size that is greater than a threshold may remain on the other side of the screen.

During operation of system 100, wet lignin 110 and one or more types of dry desiccant beads 112 may be provided to mixer 102. In some implementations, wet lignin 110, one or more types of dry desiccant beads 112, or both, may be provided to mixer 102 from corresponding transfer hoppers. Mixer 102 may be configured to mix wet lignin 110 and one or more types of dry desiccant beads 112 for a particular time period. The particular time period may be set by a control panel of mixer 102, or may be preprogrammed. In some implementations, a ratio of initial weight of one or more types of dry desiccant beads 112 to wet lignin 110 may be 2:1.

In some implementations, prior to providing wet lignin 110 to mixer 102, wet lignin 110 may be strained, which may also be referred to as wet lignin 110 being “de-lumped.” For example, wet lignin 110 may be strained or de-lumped such that wet lignin 110 has a size not greater than approximately 3/16 inches. In such an example, wet lignin 110 may be smaller than one or more dry desiccant beads 112.

Mixing wet lignin 110 and one or more types of dry desiccant beads 112 may cause moisture from wet lignin 110 to be transferred to one or more types of dry desiccant beads 112 through adsorption. This transfer of moisture may transition wet lignin 110 to dry lignin 114 and transition one or more types of dry desiccant beads 112 to one or more types of wet desiccant beads 116. The mixing process may occur at substantially room temperature, such that the mixing process may not require heating the lignin. However, the mixing process may be exothermic, resulting in temperatures that are slightly higher than room temperature, such as approximately 10 degrees higher, but not high enough to damage the lignin. After mixing, dry lignin 114 may have a moisture content that includes, or is between any two of, approximately 20%, approximately 15%, approximately 10%, approximately 5%, or approximately 1%. In some implementations, dry lignin 114 may have a moisture content of approximately 5% or less, such that illustrative dry lignin includes approximately 95% solid lignin and approximately 5% water. The moisture content of the lignin may be measured in accordance with the Tappi standard or using equipment to measure the moisture.

In addition to drying the lignin, the mixing process may reduce or eliminate a sulfurous odor of the lignin. For example, the odor of the lignin may be transferred to one or more types of wet desiccant beads 116. The odor reduction or elimination may be analyzed by performance of a sniffing test by one or more experts, such as technicians at the Centre de recherche industrielle du Quebec (CRIQ). Additionally, or alternatively, the odor reduction or elimination may be analyzed by performing a test using gas chromatography-mass spectrometry (GC-MS) that identifies various substances that may cause an odor within a test sample of the dry lignin as compared to various substances that may cause an odor within a test sample of the wet lignin. In at least some implementations, the number of substances that cause an odor in the dry lignin may be reduced, at least as compared to the wet lignin, an intensity of the substances may be reduced, or both.

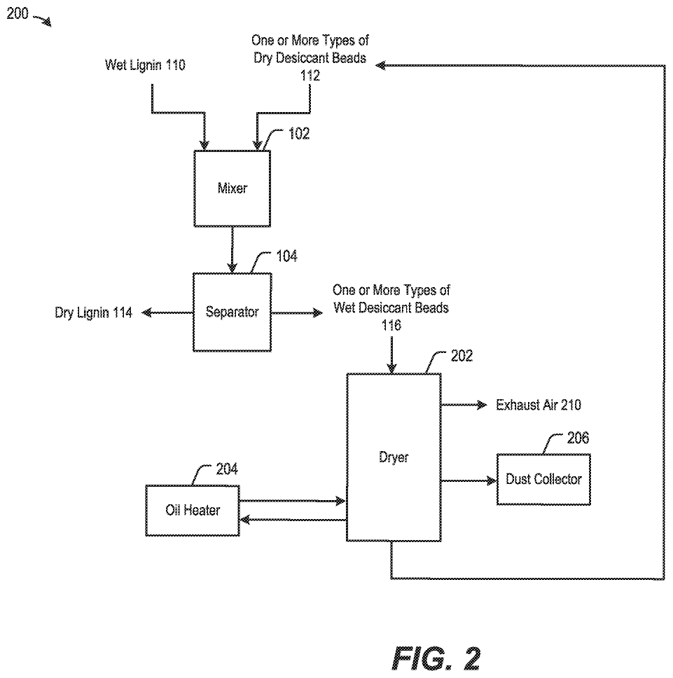

After dry lignin 114 and one or more types of wet desiccant beads 116 are formed by the mixing process in mixer 102, a mixture of dry lignin 114 and one or more wet types of desiccant beads 116 may be provided to separator 104. Separator 104 may be configured to separate dry lignin 114 from one or more types of wet desiccant beads 116. Dry lignin 114 may be an output of system 100 and may be used in one or more products. In some implementations, one or more types of wet desiccant beads 116 may be reused, after drying, as further described with reference to FIG. 2.

In some implementations, additional drying may be performed on dry lignin 114. For example, after generating dry lignin 114 from a first mixing process, dry lignin 114 may be mixed with additional types of dry desiccant beads to further dry lignin 114 and to further reduce an odor of dry lignin 114. In some such implementations, as a result of a second mixing process, dry lignin 114 may have a moisture content of less than approximately 5% and an eliminated, or severely reduced, odor. Performing multiple mixing processes in series may improve the dryness and reduce of the odor of dry lignin 114.

Thus, FIG. 1 describes system 100 for drying lignin using desiccant beads. Drying lignin by mixing the lignin with desiccant beads may provide a number of benefits. For example, the lignin may be dried at substantially room temperature, or slightly above, which may prevent degradation of the lignin as compared to drying processes that heat the lignin to higher temperatures. Additionally, the odor of the lignin may be reduced or eliminated, making the lignin suitable for use in additional products, such as food packaging. Additionally, system 100 may have a relatively small equipment footprint, thereby conserving space in a manufacturing facility. Further, the lignin may be sufficiently dried such that it can be used in a wider variety of products than in its wetter state, which may increase revenue to a manufacturer that produces the lignin. For example, the dry lignin may be used to make bio-based thermal plastics by mixing/blending the dry lignin with a polymer such as PE, PP, PVC, ABS, PS, PLA, etc., which may not be possible if the lignin has too high a moisture content.

Referring to FIG. 2, a system 200 for drying lignin and reusing desiccant beads is shown. System 200 may include mixer 102, separator 104 coupled to mixer 102, and dryer 202 coupled to separator 104. System 200 may also optionally include oil heater 204 coupled to dryer 202, and dust collector 206 coupled to dryer 202.

As described with reference to FIG. 1, mixer 102 may be configured to mix wet lignin 110 with one or more types of dry desiccant beads 112 in a mixing process that outputs a mixture of dry lignin 114 and one or more types of wet desiccation beads 116. Separator 104 may be configured to separate the dry lignin 114 from the one or more types of wet desiccant beads 116. Dry lignin 114 may be provided as an output of system 200.

Dryer 202 may be configured to receive one or more types of wet desiccant beads 116 and to dry one or more types of wet desiccant beads 116. In some implementations, dryer 202 may include a single-bank dryer that is configured to dry desiccant beads. Dryer 202 may include a plate heat exchanger, as a non-limiting example. For example, one or more types of wet desiccant beads 116 may be in direct contact with vertical plates of dryer 202. In some implementations, dryer 202 may have a capacity of up to 150 kilograms/hour (kg/h). Dryer 202 may dry one or more types of wet desiccant beads 116 by increasing the temperature of one or more types of wet desiccant beads 116. As a non-limiting example, dryer 202 may heat one or more types of wet desiccant beads 116 to a temperature that includes, or is between any two of, approximately 160° Celsius (C), approximately 165° C., approximately 170° C., approximately 175° C., approximately 180° C., approximately 185° C., approximately 190° C., approximately 195° C., approximately 200° C., approximately 210° C., approximately 220° C., approximately 230° C., or approximately 240° C. In some implementations, dryer 202 may be configured to heat wet desiccant beads 116 to a temperature of approximately 232° C./450° F. Drying one or more types of wet desiccant beads 116 may convert one or more types of wet desiccant beads 116 back to one or more types of dry desiccant beads 112. Additionally, drying one or more types of wet desiccant beads 116 may remove the odor from the lignin that was transferred to one or more types of wet desiccant beads 116 during the mixing process. As air within dryer 202 cools off, dryer 202 may be configured to output the cooling air as exhaust air 210.

Oil heater 204 may be configured to provide heated oil to dryer 202. For example, oil heater 204 may heat oil within oil heater 204 and provide the heated oil through pipes that run alongside dryer 202. The heated oil may be circulated through the vertical plates of dryer 202. The heated oil may be configured to heat dryer 202 during a drying process of one or more types of wet desiccant beads 116. As the heated oil transfers heat to dryer 202 and thereby loses heat, the oil may be cycled back to oil heater 204 for reheating. In some implementations, oil heater 204 may be an electric oil heater that is configured to operate at 18 kW.

Although dryer 202 is described as being heated by oil heater 204, in other implementations, dryer 202 may include a different type of dryer. For example, dryer 202 may be configured to heat by the application of heated air. As another example, dryer 202 may be configured to heat using convection heat. As another example, dryer 202 may be configured to heat using conduction heat. In still other implementations, dryer 202 may dry one or more types of wet desiccant beads 116 by applying pressure to one or more types of wet desiccant beads 116.

Dust collector 206 may be configured to remove dust from dryer 202. For example, the drying process of one or more types of wet desiccant beads 116 may generate dust and potentially stray lignin particles that were attached to one or more wet desiccant beads 116, and dust collector 206 may include one or more suction elements that remove the dust from within dryer 202. Alternatively, dust collector 206 may be coupled to an exhaust port of dryer 202 and may remove dust from exhaust air 210.

During operation of system 200, wet lignin 110 and one or more types of dry desiccant beads 112 may be mixed together in mixer 102 for a particular amount of time, such as a user-selected amount of time, a preprogrammed amount of time, etc. Mixing wet lignin 110 with one or more types of dry desiccant beads 112 may transfer moisture from wet lignin 110 to one or more types of dry desiccant beads 112, resulting in dry lignin 114 and one or more types of wet desiccant beads 116, as described with reference to FIG. 1. Dry lignin 114 may have a moisture content of approximately 5% or less. Dry lignin 114 may be provided as an output of system 200, to be used in making products.

One or more types of wet desiccant beads 116 may be provided to dryer 202. In some implementations, one or more types of wet desiccant beads 116 may be provided to dryer 202 via a transfer hopper or a cone. Dryer 202 may be heated by heated oil from oil heater 204. Dryer 202 may be configured to heat one or more types of wet desiccant beads 116 to dry one or more types of wet desiccant beads 116 into one or more types of dry desiccant beads 112. Once dried, and optionally deodorized, one or more types of dry desiccant beads 112 may be provided from dryer 202 to mixer 102 for subsequent mixing with additional wet lignin. Drying and reusing the desiccant beads may be referred to as a regeneration process. The same desiccant beads may be regenerated/dried and reused multiple times in the lignin drying process of system 200.

Thus, FIG. 2 describes a system for drying lignin that reuses/regenerates desiccant beads. For example, desiccant beads may be dried, such as in dryer 202 after receiving moisture from the lignin, and reused for mixing with additional lignin in the lignin drying process. Reusing the desiccant beads may reduce the cost of the materials used by system 200, which may increase revenue to the lignin manufacturer. Additionally, system 200 may have a relatively small equipment footprint, enabling system 200 to be installed in a relatively small space in a manufacturing site.

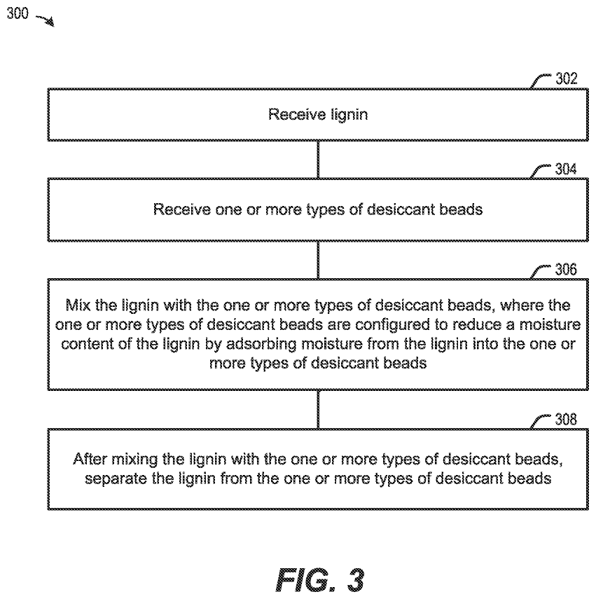

FIG. 3 illustrates a method 300 for drying lignin. In some implementations, method 300 may be performed by system 100 or system 200, or one or more components thereof.

Method 300 may include receiving lignin, at 302. For example, mixer 102 may receive wet lignin 110, such as via a transfer hopper or other input port. Method 300 may also include receiving one or more types of desiccant beads, at 304. For example, mixer 102 may receive one or more types of dry desiccant beads 112, such as via a transfer hopper or other input port.

Method 300 may include mixing the lignin with the one or more types of desiccant beads, at 306. The one or more types of desiccant beads may be configured to reduce a moisture content of the lignin by adsorbing moisture from the lignin into the one or more types of desiccant beads. For example, mixer 102 may mix wet lignin 110 with one or more types of dry desiccant beads 112. Mixing wet lignin with one or more types of dry desiccant beads 112 may transition wet lignin 110 to dry lignin 114 and transition one or more types of dry desiccant beads 112 to one or more types of wet desiccant beads 116.

Method 300 may further include, after mixing the lignin with the one or more types of desiccant beads, separating the lignin from the one or more types of desiccant beads, at 308. For example, separator 104 may receive a mixture of dry lignin 114 and one or more types of wet desiccant beads 116 and may separate dry lignin 114 from one or more types of wet desiccant beads 116.

In some implementations, the lignin may be mixed with the one or more types of desiccant beads until the lignin has approximately a 5% moisture content or less. For example, dry lignin 114 may have approximately a 5% moisture content or less, such that dry lignin 114 may include approximately 95% solid lignin and approximately 5% water. Additionally, or alternatively, the lignin may be mixed with the one or more types of desiccant beads until an odor of the lignin is reduced or eliminated. For example, a sulfurous odor of dry lignin 114 may be transferred to one or more types of wet desiccant beads 116, reducing or eliminating the odor of dry lignin 114.

In some implementations, method 300 may also include, after separating the one or more types of desiccant beads from the lignin, drying the one or more types of desiccant beads. For example, one or more types of wet desiccant beads 116 may be provided to dryer 202, and dryer 202 may dry one or more types of wet desiccant beads 116. In some such implementations, method 300 may further include, after drying the one or more types of desiccant beads, providing the one or more types of desiccant beads for mixing with additional lignin. For example, drying one or more types of wet desiccant beads 116 may transition one or more types of wet desiccant beads 116 to one or more types of dry desiccant beads 112, and one or more types of dry desiccant beads 112 may be provided from dryer 202 to mixer 102 for use in mixing with additional wet lignin.

Method 300 may thus dry lignin using desiccant beads. Because the drying occurs due to mixing with the desiccant beads, and not due to heating, degradation of the lignin may be prevented. Additionally, the odor of the lignin may be transferred to the desiccant beads, resulting in a substantially odor-free lignin that can be used in a wide variety of products, such as food packaging and other products for which lignin with an odor may not be suitable. Additionally, the dry lignin may be used in more products than the wet lignin that has a higher moisture content, such as bio-based thermal plastics made by mixing/blending the dry lignin with a polymer, such as PE, PP, PVC, ABS, PS, PLA, etc.

In some implementations, method 300 may be performed by a processor executing instructions stored on a non-transitory computer-readable storage device. For example, system 100 and/or system 200 may include a controller that includes a processor and a memory. The controller may be configured to enable the components of the respective system to perform the operations described herein. In some implementations, the controller may be distributed across one or more components of the respective system. The controller may be configured to execute instructions stored at the memory, or at a separate storage device, to perform the operations of method 300.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the ones shown may include some or all of the features of the depicted examples. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means-plus- or step-plus-function limitations, unless such a limitation is explicitly recited in a given claim using the phrase(s) “means for” or “step for,” respectively.

1. A system for drying lignin, the system comprising:
a mixer configured to receive lignin and one or more types of desiccant beads and to mix the lignin with the one or more types of desiccant beads, wherein the one or more types of desiccant beads are configured to reduce a moisture content of the lignin by adsorbing moisture from the lignin into the one or more types of desiccant beads; and
a separator coupled to the mixer and configured to separate the lignin from the one or more types of desiccant beads.

2. The system of claim 1, wherein the lignin has approximately a 35% moisture content prior to mixing in the mixer, and wherein the lignin has approximately a 5% moisture content after separation at the separator.

3. The system of claim 1, wherein an odor of the lignin is reduced after mixing in the mixer.

4. The system of claim 1, wherein the one or more types of desiccant beads comprise activated alumina desiccant beads.

5. The system of claim 4, wherein the activated alumina desiccant beads comprise porous aluminum oxide.

6. The system of claim 1, wherein the one or more types of desiccant beads comprise one or more of silica gel beads, activated charcoal, calcium sulfate, calcium chloride, calcium oxide, activated carbon, molecular sieves, montmorillonite clay, metal salts, phosphorous compounds, or combinations thereof.

7. The system of claim 1, further comprising:
a dryer coupled to the separator and configured to receive the one or more types of desiccant beads and to dry the one or more types of desiccant beads such that the one or more types of desiccant beads may be provided to the mixer for use in mixing with additional lignin.

8. The system of claim 7, further comprising:
an oil heater coupled to the dryer and configured to provide heated oil to the dryer, wherein the heated oil is configured to heat the dryer during a drying process of the one or more types of desiccant beads.

9. The system of claim 7, further comprising:
a dust collector coupled to the dryer and configured to remove dust from the dryer.

10. A method for drying lignin, the method comprising:
receiving lignin;
receiving one or more types of desiccant beads;
mixing the lignin with the one or more types of desiccant beads, wherein the one or more types of desiccant beads are configured to reduce a moisture content of the lignin by adsorbing moisture from the lignin into the one or more types of desiccant beads; and
after mixing the lignin with the one or more types of desiccant beads, separating the lignin from the one or more types of desiccant beads.

11. The method of claim 10, wherein the lignin is mixed with the one or more types of desiccant beads until the lignin has approximately a 5% moisture content.

12. The method of claim 10, wherein the lignin is mixed with the one or more types of desiccant beads until an odor of the lignin is reduced.

13. The method of claim 10, further comprising: after separating the one or more types of desiccant beads from the lignin, drying the one or more types of desiccant beads.

14. The method of claim 13, further comprising:
after drying the one or more types of desiccant beads, providing the one or more types of desiccant beads for mixing with additional lignin.

15. An article of manufacture comprising:
lignin having a moisture content of approximately 5% or less.

16. The method of claim 10, wherein the lignin has approximately a 35% moisture content prior to the mixing.

17. The method of claim 10, wherein the one or more types of desiccant beads comprise activated alumina desiccant beads.

18. The method of claim 17, wherein the activated alumina desiccant beads comprise porous aluminum oxide.

19. The method of claim 10, wherein the one or more types of desiccant beads comprise one or more of silica gel beads activated charcoal, calcium sulfate, calcium chloride, calcium oxide, activated carbon, molecular sieves, montmorillonite clay, metal salts, phosphorous compounds, or combinations there.

20. The method of claim 13, wherein drying the one or more types of desiccant beads comprises providing heated oil to a dryer, wherein the heated oil is configured to heat the dryer during a drying process of one or more types of desiccant beads.
